(19) United States
(12) Patent Application Publication
(10) Pub. No.: US 2010/0258618 A1
(43) Pub. Date: Oct. 14, 2010

(54) System and Method for Product Identification, for Tracking Individual Items on Display or in a Warehouse to Enable Inventory Control and Product Replenishment

(76) Inventors: Mark Philbrick, Kailna, HI (US); Harry George Mann, Michell (CA)

Correspondence Address: HAYNES AND BOONE, LLP;IP Section, 2323 Victory Avenue, Suite 700, Dallas, TX, 75219, US

(21) Appl. No.: 12/757,742

(22) Filed: Apr. 9, 2010

Related U.S. Application Data
(60) Provisional application No. 61/212,631, filed on Apr. 14, 2009.

(51) Int. Cl. G06F 17/00; G06K 19/06; G06K 7/10

(52) U.S. Cl. 235/375; 235/462.3; 235/470; 235/462.01

(57) ABSTRACT

A unique bar code-encoded identification is designed to be read in large number by a bar code scanner simultaneously or in continuous motion. The unique identification, known as Gentag ID, allows a specific product item to be tracked. In one implementation, that product identification is encoded using code 128 bar code, or another bar code language. In one implementation, the product identification is formed by a combination of multiple characters under the encoding scheme. In one application, a product item with the product identification is placed on a display rack among other product items having like product identification. The product identification may be provided on a surface of the product item at a preferred position, such that all of the product identifications of the products on the display rack may be read by an electronic scanner at the same time or in a continuous motion. In one application, the invention is applied to eyewear, and the product identification is affixed to a lens on each pair of glasses. Any of a large number of optical techniques may be used to provide an image of the product identification that can be read by an electronic scanning device.

### CROSS REFERENCE TO RELATED APPLICATIONS

The present application is related to and claims priority of U.S. provisional patent application (“Provisional Application”), entitled “System and Method of Product Identification, for Tracking Individual Items on Display or in a Warehouse to Enable Inventory Control and Product Replenishment,” Ser. No. 61/212,631, filed Apr. 14, 2009. The disclosure of the Provisional Application is hereby incorporated by reference in its entirety.

### BACKGROUND OF THE INVENTION

1. Field of the Invention

The present invention relates generally to product or object tracking, data collection and processing using computer-readable symbols, such as bar codes; in particular, the present invention relates to product or object tracking, data collection and processing using bar code scanning methods and strategic placements of computer-readable identification information on a product or object on display.

2. Discussion of the Related Art

Some products, such as sun glasses and corrective eyewear, belong to a product category that is characterized by extreme volatility in consumer preferences, leading to rapid changes styles and sizes. In a retail environment, the standard product movement tracking practice is by assigning a specific UPC (“universal product code”) to a specific model and size. However, while such a UPC provides sales information by model sizes and styles, the UPC does not help track movement of individual items (objects). Using a specific UPC to track an item, given the constantly changing models, sizes and styles, is a very costly approach, particularly from the administrative time viewpoint. Similarly, tracking products on display is labor intensive. Consequently, most retailers of sun glasses bundle multiple models, sizes and styles into one UPC which represents only the price level of the items. For example:

UPC: 882780400870 for all sunglasses sold at $7.95

UPC: 882780668227 for all sunglasses sold at $9.95

UPC: 882780668235 for all sunglasses sold at $12.95

UPC: 882780668249 for all sunglasses sold at $14.99

While this approach provides retailers and distributors what the sales volume, profit, and shrinkage for each price category, such an approach however does not allow tracking of individual items efficiently.

### SUMMARY

The present invention provides a unique bar code-encoded identification that may be read by a bar code scanner. The unique identification, known as Gentag ID, allows a specific product item to be tracked. According to one embodiment of the present invention, that product identification is encoded using code 128 bar code, or another bar code language. In one implementation, the product identification is formed by a combination of multiple characters under the coding scheme. In one application, a product item with the product identification is placed on a display rack among other product items having like product identification. The product identification may be provided on a surface of the product item at a preferred position, such that all of the product identifications of the products on the display rack may be read by an electronic scanner at the same time. In one application, the invention is applied to eyewear, and the product identification is affixed to a lens on each pair of glasses.

The present invention uses any of a large number of optical techniques to provide an image of the product identification that can be read by an electronic scanning device.

According to one embodiment of the present invention, a bar code scanning apparatus may be provided to include one particular mode of operation in which a large number of bar codes can be read in a single sweep-scanning motion by a portable scanner, without having to scan each bar code individually. In one implementation, the bar code scanning apparatus, includes (i) a portable bar code scanner having a control interface for receiving command signals, the portable bar code scanner having (a) a standby state awaiting activation and (b) an activated state in which the bar code scanner reads and decodes a bar code within a predetermined field of view, and wherein the bar code scanner further having (a) a first operating mode in which the bar code scanner, having entered the activated state as a result of a first command received over the control interface, returns to the standby state after a successful reading of a bar code without receiving a further command over the control interface; and (b) a second operating mode in which the bar code scanner, after entering the activated state as a result of receiving a second command over the control interface, stays in the activated state; and (ii) a control unit, which includes (a) a program memory storing a control program that controls the operations of the portable bar code scanner; and (b) a processor for executing the control program, wherein the control program selectively provides, during operation, the first command or the second command to the portable bar code scanner over the control interface. The continuous scanning mode may be initiated by a user action (e.g., depressing a trigger or key, or providing a voice command). The continuous scanning mode may be initiated by a special reserved bar code, or a special embedded character of the bar code alphabet. The portable bar code scanner does not transmit to the processor duplicate bar codes in a scanning session.

According to another embodiment of the present invention, a voice-activated electronic scanner is provided.

The present invention is better understood upon consideration of the detailed description below in conjunction with the accompanying drawings.

### BRIEF DESCRIPTION OF THE DRAWINGS

FIG. 1 shows a bar code scanner that allows continuous scan of multiple Gentag IDs on products displayed on a retail display rack, according to one embodiment of the present invention.

FIG. 2 compares the placement practice of a UPC tag in the prior art with the placement of a Gentag ID, which allows the efficient sweep-scan operation of FIG. 1, in accordance with one embodiment of the present invention.

FIG. 3 is a block diagram illustrating a voice-activated bar code scanner, in accordance with one embodiment of the present invention.

FIG. 4 shows one example of such a multiple-image hologram label affixed to the frontal plane of the lens, in accordance with one embodiment of the present invention.

### DETAILED DESCRIPTION OF THE PREFERRED EMBODIMENTS

The present invention provides a unique bar code-encoded identification that may be read by a scanner without moving the object to which the unique bar code-encoded identification is affixed. Although the present invention is illustrated using examples from the eye glasses industry, the present invention is applicable to tracking any object that can be stored in a warehouse or in a retail environment, such as sun glasses and corrective eyewear retail outlets. Further, although the present invention and its use are illustrated by bar code scanners, the present invention can also be carried out using any suitable object tracking device, such as an RF scanner (i.e., readers of an radio frequency (RF) chip).

Under the present invention, to track movement of product items on and off their display racks, each product item is provided identification (ID) that is unique to the product item. Such an ID, which may be provided on a label and represented by bar codes, may be affixed to the product item either by adhesive or by static treatment of the label material. In one embodiment, in which the object tracked is a pair of sun glasses, the label may be placed on a front-facing part of the lens, the front part of a frame, or on an area of the arms of a frame that is visible from an angle, so that the ID may be read by a portable scanner, without having to move the sun glasses on or off the display rack to properly orient the bar code for scanning. Because the ID can be read without removing or manipulating the sun glasses (object) into position for the scanner, productivity gains (of over 500%) for inventory tracking activities can be achieved. The knowledge of what remains on the display rack (i.e., yet to be sold) versus what is no longer on the display rack (i.e., presumably sold) allows tracking specific pairs of glasses (hence specific customer preferences) and allows the information to be used in an automated product reorder fulfillment system. This arrangement provides in-depth market knowledge of how long a specific pair of glasses remains on display, and if a particular pair of glasses has been moved from one position on the display rack to another. Additionally, the system is capable of determining if a pair of glasses has been moved from one rack to another (e.g., in a different part of the store), and thus does not lose track of the pair of the glasses. Such a capability is valuable, for example, inventory purposes.

According to one embodiment of the present invention, the unique eyewear glass ID may be formed by a group of characters that is represented, for example, in a bar code language, such as code 128. In one implementation using code 128, each code 128 bar code symbol or character may represent multiple alphanumeric characters, including upper case and lower case letters, numerals (i.e., 0 through 9), and other special symbols. The unique ID (“Gentag ID”) is formed out of multiple code 128 characters. For example, a 3-character ID can provide up to 830,584 Gentag IDs. Similarly, a 4-character ID can provide up to 78,074,896 Gentag IDs and a 5-character identification string can represent 7,339,040,224 Gentag IDs. The Gentag ID may be each uniquely assigned to a specific product item at the time of manufacturing to encode information specific to the product item, such as the date of manufacturing, a model number, a serial number, a style, a size or another characteristic of interest. The Gentag ID allows more accurate inventory control than when a UPC is shared by a number of products. Without unique encoding, an inventory clerk often scans the same UPC as many times as the number of pairs of eye glasses remaining on the display rack, so as to provide an inventory count. Such a method is, of course, tedious and error-prone.

The Gentag IDs may be stored in a table or in a database (e.g., in a portable computer) to allow an operator to access any object which is assigned a Gentag ID. The Gentag IDs make available detailed marketing information to the operator and allow efficient inventory management, such as replenishing the replacement inventory. One embodiment of the present invention tracks an item or object (e.g., a pair of glasses) using a Gentag ID which is formed out of characters of an efficient bar code standard. The Gentag ID may be placed in such a manner to allow the product being tracked to be on display (e.g., on a rack), so that the Gentag ID characters (e.g., numbers, upper and lower letters, and specific characters) may be easily read by a worker and may be scanned with a bar code scanner without touching or otherwise manipulating the object or its Gentag ID label.

In the grocery trade, a bar code scanner is typically configured to be continuously “on” to read the UPC of each product presented to the scanner. In the typical scanner in the grocery store, the operator moves each product (or object) through the scanning window of a scanner to allow the identification bar code affixed to the product to be moved across the scanner's field of vision. Such a mechanism is not efficient for reading Gentag IDs affixed to products placed on a retail display rack.

Another typical portable or hand-held bar code scanner may be integrated into a handheld computer. In such a portable hand-held scanner, the scanning mechanism is triggered or keyed “on” by an operator, and would remain “on” until a bar code is successfully read. After successfully read and decode a bar code, the scanning mechanism would then automatically shut off. Some bar code scanners are part of a “personal digital assistant” (PDA) or a handheld computer in which the bar code scanner is triggered by a button on a keyboard. Other methods commonly used for activating or triggering the “on” operating mode of a bar code reader include using a motion detector or a proximity switch. Alternatively, one portable scanner has the scanning mechanism remain “on” so long as the trigger is held “on” by the operator, or until a pre-set duration expires. Upon expiration of the pre-set duration, the operator must depress the trigger or the scanner key again to turn on the scanner. Such a hand-held scanner may be made even more efficient for reading Gentag IDs affixed to products placed on a retail display rack if the automatic shutting-off feature of the handheld bar code scanner is disabled to allow a continuous reading of all the Gentag IDs using a single scan motion.

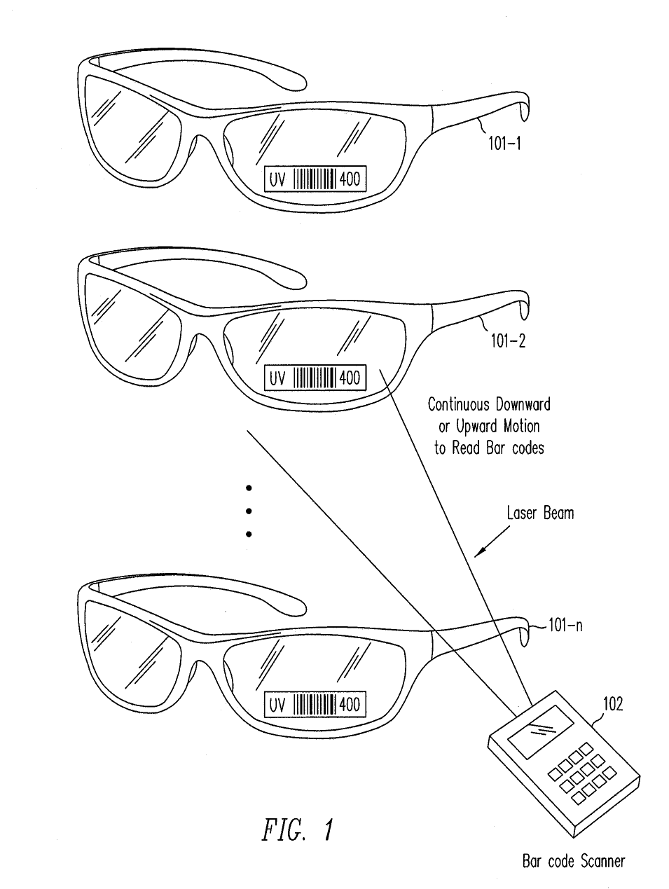

FIG. 1 shows a bar code scanner that allows continuous scan of multiple Gentag IDs on products displayed on a retail display rack, according to one embodiment of the present invention. As shown in FIG. 1, eye glasses 101-1 to 101-n are arranged to have their lenses facing the same direction, with each pair of eye glasses having a Gentag ID affixed on one of its lenses. The Gentag IDs on these eye glasses may be read by a continuously “on” portable scanner 102, using a sweeping motion. Portable scanner 102 includes software which turns “off” and “on” the bar code continuous scanning mechanism. Such software may implement one of the following methods in a typical handheld or portable bar code scanner:
1. According to one method, software in a handheld computer receives a user command which configures a scanner device to remain in the scanning mode, rather than automatically terminating the scanning mode after a successful reading and decoding of a Gentag ID. Remaining in the scanning mode allows additional Gentag IDs to be read and decoded. The software maintains a list of Gentag IDs that are already read and decoded since the beginning of the current continuous scanning mode session. The software checks each successfully read and decoded Gentag ID against the list, so that each Gentag ID read and decoded is sent to the host computer only once during each session. A second user command terminates the current continuous scanning mode session.
2. According to a second method, a special reserved Gentag ID may trigger a bar code scanner to enter into a special operating mode (e.g., into a continuously “on” scanning mode that reads and decodes multiple Gentag IDs coming into the scanner's view without shutting off after successfully decoding each Gentag ID). For example, in that special scanning mode, when the special reserved Gentag ID is read and decoded, the continuously “on” scanning mode is entered. Otherwise, the bar code scanner shuts off after each Gentag ID is successfully scanned and decoded. Using the special operating mode (i.e., a continuously “on” scanning mode), all the Gentag IDs affixed to eye-glasses on a rack may be read and decoded during the scanning mode session without reactivation of the bar code scanner after successfully reading and decoding each Gentag ID, Similarly, a second special reserved Gentag ID returns the bar code scanner to automatically shutting off mode of operation after each successful reading and decoding of a Gentag ID
3. According to a third method, an embedded command character may be embedded in each Gentag ID to enable the bar code scanner to remain “on” after reading and decoding such a Gentag ID, so that all Gentag IDs on products in the same rack may be read continuously, until a standard bar code is read, which returns the bar code scanner back to the “default” state (i.e., the operating state which automatic shuts-off the bar code scanner after each successful reading of a bar code). This third method can be achieved using software which examines decoded bar code for the embedded command character to decide whether to remain “on” or to return to the default state. As in the other methods, the software keeps track of the Gentag IDs already read during each session, so that only Gentag IDs that have not been sent previously are sent to the host processor.

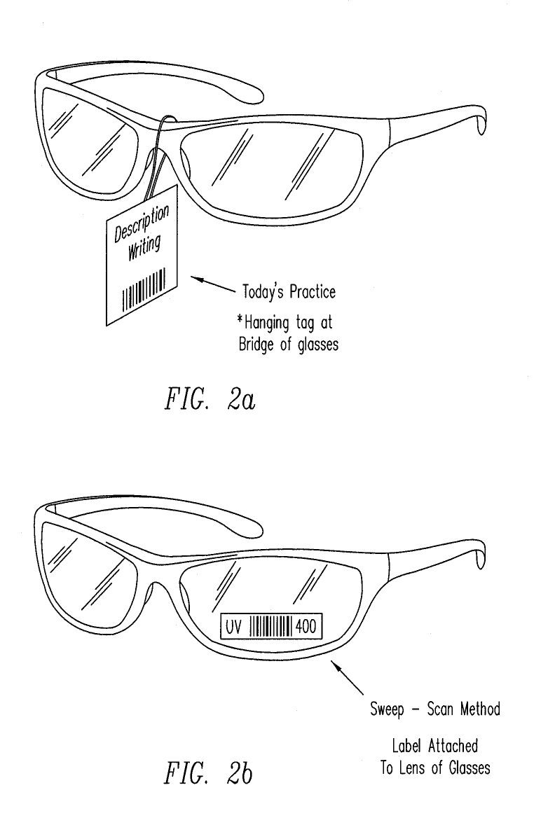

FIG. 2 compares the placement practice of UPC tags in the prior art with the placement of an Gentag ID, which allows the efficient sweep-scan operation of FIG. 1, in accordance with one embodiment of the present invention. In the prior art, as shown in FIG. 2a, the UPC tag is typically hanged off the bridge of the pair of eye glasses, with little or no effective control of the direction in which the UPC tag faces. In contrast, as shown in FIG. 2a, by placing the Gentag ID at a prescribed position on one of the lenses of the pair of eye glasses, a large number of Gentag IDs may be read simultaneously using any of the methods illustrated by FIG. 1.

The Gentag ID may be provided as a “see-through” bar code affixed to the surface of a lens using conventional one-way glass technology. In the conventional one-way glass technology, a coating on the lens reflects most of light from the surface of the lens, so that, from the outside (i.e., looking into the lenses), the coating appears as a solid surface. On the other hand, to the person behind the glass (i.e., the person wearing the pair of eye glasses), sufficient light passes through the coating, such that the person behind the glass sees the coating as substantially completely transparent. A Gentag ID provided by such a coating would appear as a solid label from the outside, but is transparent to the person wearing the eye-glasses.

Alternatively, the Gentag ID may be provided as a hologram label. Such a hologram label is clear and completely transparent when observed from either directly in front of the lens or directly behind the lens. The image of the hologram label is, however, visible when viewed from an angle. Besides the Gentag ID, additional information (e.g., a brand logo, a model number or a “UV 400 Protection” informational message) may also be provided on the hologram label. Such a hologram label may be used when a visible label on the lens is not considered acceptable to the consumer.

In another alternative embodiment, the hologram label is completely clear and transparent when viewed from both directly behind the lens or directly in front of the lens, except for the black portions of the bar code characters in the Gentag ID, which is visible. Such a hologram label, like a window screen, provides little obstruction to the view seen by the wearer. When scanning from an angle to the frontal plane of the lens, the bar code scanner sees the Gentag ID from an image formed by the black portions of the bar code characters and the transparent portions between black portions. When the pair of eye glasses is placed on a opaque color display rack (e.g., white), the transparent portions would appear at the angle as the white portions of the bar code between the black portions. Therefore, an operator taking inventory may hold a bar code scanner at that angle to read the complete Gentag ID. The bar code scanner may be programmed to provide an audible signal to inform the operator that the Gentag ID is successful read.

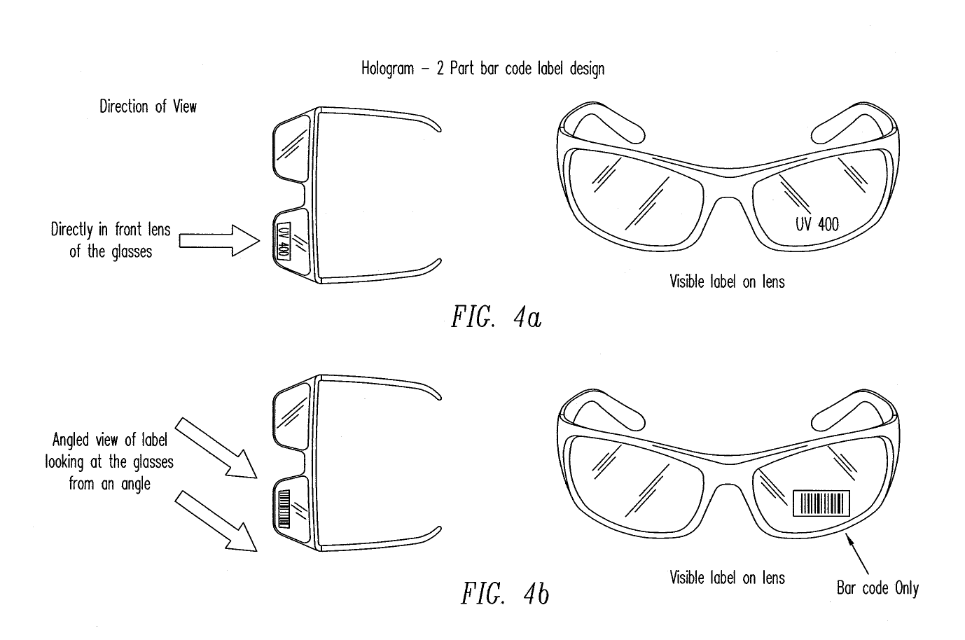

In yet another alternative embodiment, the Gentag ID is provided as one of several images embedded in the hologram label. As is known in the art, multiple images may be present in a hologram. Such a hologram label allows the embedded images to serve several functions in a limited amount of space. FIG. 4 shows one example of such a multiple-image hologram label affixed to the frontal plane of the lens, in accordance with one embodiment of the present invention. As shown in FIG. 4a, multiple image hologram label 401 is affixed on a lens of a pair of eye glasses. The hologram label is clear when viewed directly in front of the lens, except for the white lettering of an image providing product information (e.g., “UV400 Protection”). However, as seen from FIG. 4b, when an observer views the hologram label from an angle, a different image is seen, which provides the Gentag ID. In such an image, the white portions of the bar code characters are seen as solid, while the black portions of the bar code are seen as transparent. A second label, which includes a semi-transparent dark tint, is provided on the back side of the lens behind the first hologram label. This second label provides a better black background for viewing the black portions of the bar code to allow a bar code scanner to read the Gentag ID. The second hologram label may include a third hologram image (e.g., a corporate logo or some advertising) to be seen when viewed directly at the back side of lens.

Another embodiment provides a clear or transparent label, which is to be affixed on the front side of the lens. The transparent label includes only visible dark or black lines that represent the black portions of the bar code characters of a Gentag ID, printed in a non-hologram standard form. The Gentag ID may be printed using any conventional printing technology. The dark lines, like a window screen, provides little or no obstruction of the view for a viewer from behind the lens, as the label is basically transparent. In addition, a second label is affixed to the back side of the lens behind the front label. This back label may be a tinted white label or a hologram label that appears white when viewed from an angle. The back label may also be a multiple image hologram label, such as that discussed above. To read the Gentag ID, an operator holds a bar code scanner at the angle, such that an image of the black portions from the front label superimposes onto the white image from the back label to provide the readable Gentag ID.

Yet another embodiment prints a Gentag label using ultraviolet-sensitive ink (“ultraviolet ink”) on a clear or transparent label, or directly onto the lens of a pair of eye glasses. The printed image is invisible to the human eye under lighting conditions in the visible spectrum. However, when illuminated by ultraviolet light, an image can be detected, for example, by an image scanner or by a digital camera. The recorded image may be provided to software in a computer (e.g., a desktop, tablet or laptop computer) for recognition and decoding. The resulting data from the recognition process may be used, for example, for inventory control, as discussed above. If the ultraviolet ink image is directly written onto the lens, the Gentag ID remains on the pair of eye glasses for the life of the lens.

A bar code scanner which requires a trigger to be held during operation is inconvenient or cumbersome in certain warehouse, route delivery, or medical applications. For example, in warehouse picking and route delivery, even though there is a need to read a bar code, it is also valuable to free the operator's hands to pick up boxes or objects than to be constantly holding down a trigger or key on the bar code reader. In the prior art, the automation identification industry has various types of ring scanners and top-of-hand scanners. A ring scanner is secured to a finger and has a trigger on a side of the ring for turning “on” or “off” the scanning operating mode. In one such bar code scanner, the operator points to a bar code and uses the thumb to depress the trigger to turn “on” the scanner. Such a device remains awkward and can inhibit the picking process. Similarly, a top-of-hand device also requires depressing a trigger. Such a trigger is awkward to use, and may injure the operator (e.g., carpal tunnel syndrome).

According to another embodiment of the present invention, the operation of a bar code scanner, including the continuous “on” scanning mode described above, can be activated by a voice command. Such a bar code scanner is both useful in the sweep-scan operation described with respect to FIG. 1, and in the many applications described above. In the medical field, for example, a hands-free bar code reader or RF scanner operation is valuable in eliminating contamination through touching a trigger or a button in a bar code scanner or an RF scanning device. In one embodiment, using conventional voice recognition technology, software in a computer or a cell phone can generate a command to activate a bar code scanner or an RF scanner to read a bar code or RF chip.

A voice-activated bar code scanner of the present invention may be attached to a person's wrist, similar to how a watch is normally worn. To operate such a bar code scanner, the operator points the bar code scanner on his wrist towards the bar code (e.g., a Gentag ID) to be read and “voice in” the command to activate the bar code reading circuit. Using conventional voice recognition technology, software in a host computer activates a laser or a charge-coupled device (CCD) bar code scanning mechanism in the bar code scanner to decode each bar code within its field of vision, and to transmit the resulting data back to the host computer. The bar code scanner may be directly embedded in or connected through a wired or wireless connection with the host computer. Similarly, when the operator wishes to read an RF chip, the operator would bring the reading device on the wrist to the proximity of the RF chip and activates the RF scanner via a voice command, which is processed by conventional voice recognition technology in the software of the host computer, as discussed above. Alternatively, the operator would simply be positioned close to the inventory that is being audited and the RF scanner, which may be a hands-free waist, belt-carried device, may read and identify all the RF tags that are present and within the range of the RF scanner. The bar code scanner of the present invention may also be designed to have two alternative methods of activation (e.g., through a standard trigger or a key on a keyboard, as conventionally provided, while at the same time allowing activation by a voice command).

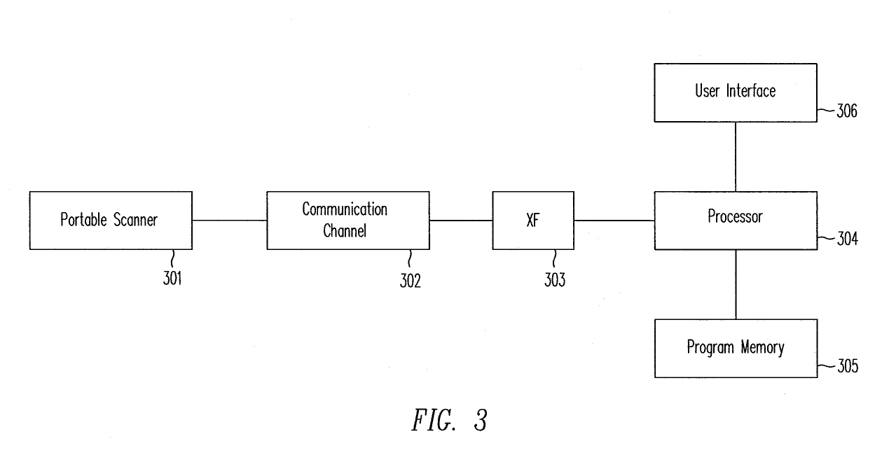

FIG. 3 is a block diagram illustrating the operation of a voice-activated bar code scanner, in accordance with one embodiment of the present invention. According to one embodiment of the present invention, initially, an operator places bar code scanner 301 in a ready or stand-by state. Bar code scanner 301 is controlled via connection 302 (e.g., either a wired connection or a wireless connection) to interface 303 of a computer, which includes processor 304 that runs software from program memory 305. The software controls voice input interface 306 (e.g., a wired or wireless microphone). During operation, the operator speaks a voice command into voice input interface 306, which is recognized by software running in processor 304. Upon recognition of the command, the software executed in processor 304 causes a signal to be sent to bar code scanner 301 through interface 303 to activate scanning. Bar code scanner 301 reads and decodes the bar code and sends the decoded data back to the host computer over interface 303, whereupon host computer 304 deactivates and returns bar code scanner 301 back to the ready or stand-by state initially placed by the operator. Bar code scanner 301 also includes a trigger or key for activating the continuous scanning mode described above. During the operation using the trigger or key, a signal is sent over connection 302 to processor 304. The processor 304 execute software that implements one or more the methods described above.

Alternatively, the bar code scanner may be attached to the operator's eyewear or mounted on a head band, such that a bar code within the line of sight of the bar code scanner may be read by voice. Such a bar code scanner would be particularly valuable in a medical application.

In addition to activating the bar code scanner, voice recognition can also be used to supplement the data from reading of the bar code. For example, additional data may be entered using speech. For example, after the operator voice-activated the bar code scanner to read a bar code, the operator may provide by voice also other details (e.g., quantity or condition of the bar-coded object or objects, such as valuable for an inventory taking operation).

The above detailed description is provided to illustrate the specific embodiments of the invention and is not intended to be limiting. Numerous modifications and variations within the scope of the present invention are possible. The present invention is set forth in the following claims.

We claim:

1. An identification for a product item comprising an article of manufacture affixed to a predetermined position on the product item, the article of manufacture providing a computer-readable image that encodes information that uniquely identifies the product item, the image being expressed in a bar code alphabet.

2. An identification as in claim 1, wherein the bar code alphabet is at least in part code 128.

3. An identification as in claim 1, wherein the product item is placed on a display rack among a plurality of other product items each being providing a like identification.

4. An identification as in claim 3, wherein the identification is provided on a surface of the product item, the surface of the product item and corresponding surfaces of the other like product items being oriented by the display rack to face a predetermined direction.

5. An identification as in claim 4, wherein the product item comprises a pair of eye glasses, and wherein the surface of the product item comprises a side of a lens of the pair of eye glasses.

6. An identification as in claim 4, wherein the identification is provided on the surface of a product item using a one-way glass technology.

7. An identification as in claim 4, wherein the identification is provided on a hologram label affixed to the surface of the product item, the hologram label providing an image of the identification when viewed from an angle relative to a normal to the surface.

8. An identification as in claim 4, wherein the identification is provided on a transparent label affixed to the surface of the product item, the transparent label having provided thereon a dark portion of the identification, and wherein when viewed from an angle relative to a normal to the surface, the portion of the transparent portion of the label not occupied by the dark portion appears opaque to form, together with the dark portion, a complete image of the identification.

9. An identification as in claim 4, wherein the identification is provided on a multiple image hologram label in which an image of the identification is one of the multiple images.

10. An identification as in claim 9, wherein the image of the identification is configured to be visible when viewed at an angle relative to a normal of the surface.

11. An identification as in claim 9, wherein the multiple image hologram label appears transparent when viewed directly at the surface, wherein the identification comprises a first portion and a second portion of contrasting colors, and wherein, when viewed at the angle, the image of the identification is formed by an opaque portion, representing the first portion, and a transparent portion, representing the second portion.

12. An identification as in claim 11, wherein a semi-transparent label is provided on an opposite side of the surface such that, when viewed from the angle, the semitransparent label allows the second portion of the identification to become visible to allow reading by an electronic scanner.

13. An identification as in claim 4, wherein the display rack is provided in a first color, and wherein the identification is provided on a transparent label affixed to the surface of the product item, the transparent label having provided thereon a portion of the identification rendered in a color contrasting to the first color, such that the first color of the display rack coming through the transparent label and the portion of the identification form a complete image of the identification to allow reading by an electronic scanner.

14. An identification as in claim 4, wherein the identification is provided on a transparent label affixed to the surface of the product item, the transparent label having provided thereon a portion of the identification rendered in a dark color, wherein a second label is provided affixed to a second surface of the product item, such that, when viewed at an angle relative to a normal of the surface to which the transparent labeled is affixed, the second label provides an image that provides a background to the image provided by the transparent label, so that a complete image of the identification is provided to allow reading by an electronic scanner.

15. An identification as in claim 4, wherein the identification is provided on the surface of the product item using an ultraviolet-sensitive ink.

16. An identification as in claim 15, wherein the ultraviolet-sensitive ink is printed on a transparent label affixed on the surface of the product item.

17. An identification as in claim 15, wherein the ultraviolet-sensitive ink is printed on the surface of the product item directly.

18. A bar code scanning apparatus, comprising:
a portable bar code scanner having a control interface for receiving command signals, the portable bar code scanner having (a) a standby state awaiting activation and (b) an activated state in which the bar code scanner reads and decodes a bar code within a predetermined field of view, and wherein the bar code scanner further having (a) a first operating mode in which the bar code scanner, having entered the activated state as a result of a first command received over the control interface, returns to the standby state after a successful reading of a bar code without receiving a further command over the control interface; and (b) a second operating mode in which the bar code scanner, after entering the activated state as a result of receiving a second command over the control interface, stays in the activated state; and
a control unit, comprising:
a program memory storing a control program that controls the operations of the portable bar code scanner; and
a processor for executing the control program, wherein the control program selectively provides, during operation, the first command or the second command to the portable bar code scanner over the control interface.

19. A bar code apparatus as in claim 18, wherein the control program receives a user command from a user interface.

20. A bar code apparatus as in claim 19, wherein the user interface comprises a trigger or a key on a key pad.

21. A bar code apparatus as in claim 19, wherein the user interface comprises a voice input interface.

22. A bar code apparatus as in claim 18, wherein the control program provides the second command to the portable bar code scanner, upon successfully decoding a special reserved bar code.

23. A bar code apparatus as in claim 18, wherein the control program provides the second command to the portable bar code scanner, upon successfully decoding a bar code having a predetermined embedded command character.

24. A bar code apparatus as in claim 18, wherein the portable bar code scanner maintains a list of bar codes decoded with the second operating mode and compares each decoded bar code against the list and returns the decoded bar code to the control unit only when the decoded bar code is not found in the list of bar codes decoded.

25. A bar code apparatus as in claim 24, wherein the portable bar code scanner provides an audible sound to indicate successful decoding of a bar code.

26. An electronic scanning apparatus, comprising:
a portable electronic scanner having a control interface for receiving command signals; and
a control unit, comprising:
a voice input interface for receiving a voice command;
a program memory storing a control program that controls the operations of the portable electronic scanner, the control program comprising a voice recognition module that recognizes the voice command; and
a processor for executing the control program, wherein the control program provides, during operation, a command to operate the portable electronic scanner over the control interface based on receiving and recognizing a voice command received at the voice input interface.

27. An electronic scanning apparatus as in claim 26, wherein the portable electronic scanner reads and decodes bar codes.

28. An electronic scanning apparatus as in claim 26, wherein the portable electronic scanner reads and decodes radio frequency integrated circuit devices.

29. An electronic scanning apparatus as in claim 26, wherein the portable electronic scanner is configured to be worn on a human wrist.
